(19) United States
(12) Patent Application Publication
(10) Pub. No.: US 2026/0187316 A1
(43) Pub. Date: Jul. 2, 2026

(54) SEMICONDUCTOR 3D STRUCTURE GENERATING DEVICE AND OPERATION METHOD THEREOF

(71) Applicant: Samsung Electronics Co., Ltd., Suwon-si (KR)

(72) Inventors: Dayoung Ryu, Suwon-si (KR); Ji-Seong Doh, Suwon-si (KR); Jaehyun Bae, Suwon-si (KR); Siho Song, Suwon-si (KR); Jaewoong Lee, Suwon-si (KR); Dong Hyeok Im, Suwon-si (KR); Jaehoon Jeong, Suwon-si (KR)

(21) Appl. No.: 19/287,045

(22) Filed: Jul. 31, 2025

(30) Foreign Application Priority Data
Dec. 30, 2024 (KR) 10-2024-0200804

(51) Int. Cl. G06F 30/27; G03F 7/00; G06F 111/14

(52) U.S. Cl. CPC G06F 30/27; G03F 7/706841; G06F 2111/14

(57) ABSTRACT

A method of operating a semiconductor 3D structure generating device includes receiving a first input optical critical dimension (OCD) spectrum with respect to a first semiconductor pattern formed on a semiconductor wafer from an external measuring device, extracting a plurality of first input structure values based on the first input OCD spectrum, generating a first candidate database including information on a plurality of first candidate structures based on the plurality of first input structure values, determining one first candidate structure among the plurality of first candidate structures of the first candidate database based on the plurality of first input structure values and the first input OCD spectrum, and generating a first 3D structure corresponding to the first semiconductor pattern by simulating the selected one first candidate structure.

### CROSS-REFERENCE TO RELATED APPLICATION(S)

This application claims priority under 35 U.S.C. § 119 to Korean Patent Application No. 10-2024-0200804 filed on Dec. 30, 2024, in the Korean Intellectual Property Office, the disclosure of which is incorporated by reference herein in its entirety.

### BACKGROUND

Semiconductor devices may be manufactured through various processes. As semiconductor design technologies develop, the number of processes for manufacturing semiconductor devices, complexity of each process, or the degree of integration of a semiconductor device is increasing. Accordingly, various defects or faults may occur during semiconductor manufacturing processes.

### SUMMARY

To ensure the performance and reliability of semiconductor devices, it may be desired to confirm whether the semiconductor devices or wafers manufactured or produced in each process are manufactured or produced normally. As an example, a non-destructive measurement of semiconductor devices manufactured or produced in each process may be performed through an OCD (Optical Critical Dimension) measurement. However, information obtained through the OCD measurement may be optical spectrum information, and only numerical values for some parts of the semiconductor device may be measured or calculated through the optical spectrum information. That is, numerical values with respect to parts not obtained through the optical spectrum information may not confirmed, and in this case, defects in the semiconductor manufacturing process may not be easily detected.

Implementations according to the present disclosure provide a semiconductor 3D (three-dimensional) structure generating device with improved performance and improved reliability, and an operation method thereof.

An aspect of the present disclosure provides a method of operating a semiconductor 3D structure generating device. The method includes receiving a first input optical critical dimension (OCD) spectrum with respect to a first semiconductor pattern formed on a semiconductor wafer from an external measuring device, extracting a plurality of first input structure values based on the first input OCD spectrum, generating a first candidate database including information on a plurality of first candidate structures based on the plurality of first input structure values, selecting one first candidate structure among the plurality of first candidate structures of the first candidate database based on the plurality of first input structure values and the first input OCD spectrum, and generating a first 3D structure corresponding to the first semiconductor pattern by simulating the selected one first candidate structure.

Another aspect of the present disclosure provides a method of operating a semiconductor 3D structure generating device. The method includes receiving a first input optical critical dimension (OCD) spectrum with respect to a first semiconductor pattern formed on a semiconductor wafer from an external measuring device, generating a first 3D structure corresponding to the first semiconductor pattern based on the first input OCD spectrum, receiving a second input OCD spectrum with respect to a second semiconductor pattern formed on the semiconductor wafer from the external measuring device, and generating a second 3D structure corresponding to the second semiconductor pattern based on the second input OCD spectrum and the first 3D structure, and the first semiconductor pattern is formed through a first process with respect to the semiconductor wafer, and the second semiconductor pattern is formed through a second process performed after the first process with respect to the semiconductor wafer.

Another aspect of the present disclosure provides a semiconductor 3D structure generating device. The semiconductor 3D structure generating device includes a structure value extracting module that receives a first input optical critical dimension (OCD) spectrum with respect to a first semiconductor pattern formed on a semiconductor wafer from an external measuring device and extracts a plurality of first input structure values based on the received first input OCD spectrum, a candidate database generating module that generates a first candidate database including information on a plurality of first candidate structures corresponding to the first semiconductor pattern based on the plurality of first input structure values, a 3D structure selecting module that selects one first candidate structure corresponding to the first input OCD spectrum and the plurality of first input structure values from among the plurality of first candidate structures of the first candidate database, and a 3D structure modeling module that generates a first 3D structure corresponding to the first semiconductor pattern by simulating the selected one first candidate structure.

### BRIEF DESCRIPTION OF THE DRAWINGS

FIG. 1 is a block diagram illustrating a semiconductor manufacturing system.

FIG. 2 is a diagram for describing an operation of a measuring device of FIG. 1.

FIG. 3 is a flowchart illustrating an operation of a semiconductor manufacturing system of FIG. 1.

FIG. 4 is a flowchart illustrating in detail operation S1200 of FIG. 3.

FIG. 5 is a block diagram illustrating a 3D structure generating device of FIG. 1.

FIG. 6 is a diagram illustrating a structure value extracting module of FIG. 5.

FIG. 7 is a block diagram illustrating a candidate database generating module of FIG. 5.

FIG. 8 is a flowchart illustrating operation S1220 of FIG. 4 and an operation of a candidate database generating module of FIG. 7.

FIG. 9 and FIG. 10 are diagrams for describing a pre-database and a candidate database generated by a candidate database generating module of FIG. 7.

FIG. 11 is a block diagram illustrating a 3D structure selecting module of FIG. 5.

FIG. 12 is a diagram for describing an operation of using a 3D structure of a previous step in a 3D structure generating device of FIG. 5.

FIG. 13 is a block diagram illustrating another example of a candidate database generating module of FIG. 5.

FIG. 14 is a flowchart illustrating an operation of a candidate database generating module of FIG. 13.

FIG. 15 is a block diagram illustrating a semiconductor manufacturing system.

### DETAILED DESCRIPTION

Hereinafter, implementations of the present disclosure may be described in detail and clearly to such an extent that an ordinary one in the art easily implements the present disclosure.

Terms such as “block”, “unit”, “module”, etc. used below, or their corresponding configurations, or functional blocks or circuits in the drawings, may be implemented in the form of software, hardware, or a combination thereof configured to perform or process various functions, operations, or features described in the detailed description.

Hereinafter, when various components are listed using the conjunction “or”, this may refer to each of the listed components, or at least some combination thereof. For example, “A, B, or C” may refer to A, B, and C respectively, or a combination of A and B, a combination of B and C, a combination of A and C, or a combination of A, B, and C.

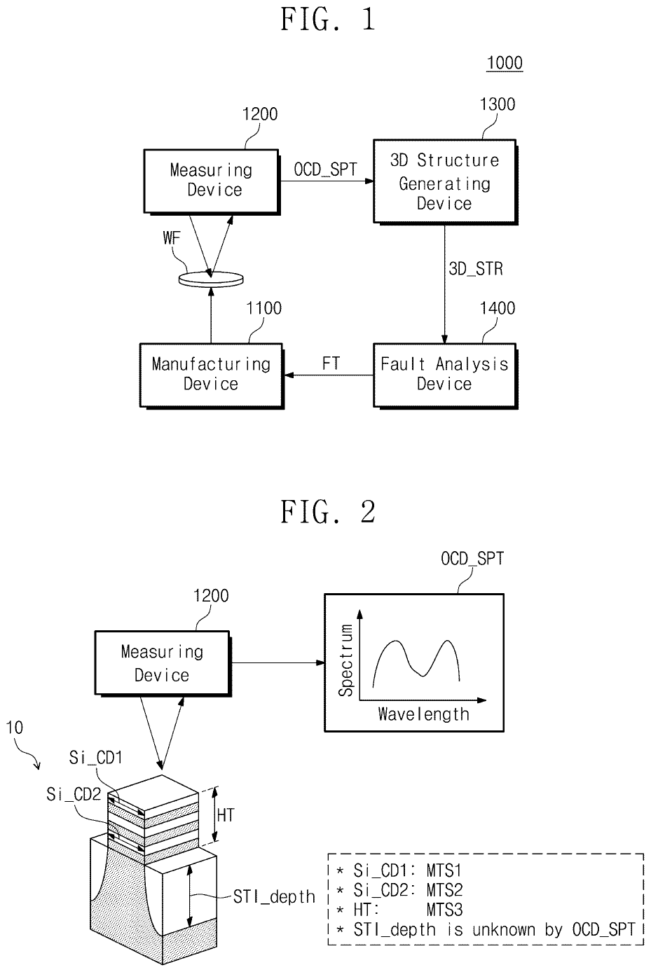

FIG. 1 is a block diagram illustrating a semiconductor manufacturing system, according to some implementations of the present disclosure. Referring to FIG. 1, a semiconductor manufacturing system 1000 may include a semiconductor wafer WF, a manufacturing device 1100, a measuring device 1200, a 3D structure generating device 1300, and a fault analysis device 1400.

The semiconductor wafer WF may be used as a substrate of semiconductor. For example, the wafer WF may include a material having a semiconductor characteristic, such as silicon (Si) or gallium arsenic (GaAs). The manufacturing device 1100 may perform various processes for manufacturing the semiconductor wafer WF. For example, the manufacturing device 1100 may perform various processes such as an etching process, a deposition process, and a planarization process on the semiconductor wafer WF, thereby generating various semiconductor patterns on the semiconductor wafer WF or manufacturing the semiconductor wafer WF having various semiconductor patterns.

The measuring device 1200 may perform a non-destructive measurement on the semiconductor wafer WF. For example, the measuring device 1200 may operate based on an optical critical dimension (OCD) measurement method. For example, the measuring device 1200 may irradiate light to the semiconductor wafer WF and may receive light reflected from the semiconductor wafer WF. The measuring device 1200 may generate spectrum information (hereinafter, referred to as an OCD spectrum OCD_SPT for convenience of description) based on the received light. In some implementations, even if the semiconductor wafer WF undergoes the same manufacturing process, semiconductor patterns on the semiconductor wafer WF may have different physical shapes due to various process deviations. As a result, the spectrum information of light reflected from each semiconductor pattern may be different from each other. In other words, the OCD spectrum OCD_SPT obtained from the measuring device 1200 may include information on semiconductor patterns, semiconductor devices, or semiconductor structures included in the semiconductor wafer WF. In some implementations, the measuring device 1200 is described as using the OCD measuring method, but the scope of the present disclosure is not limited thereto, and the measuring device 1200 may perform measurements on the semiconductor wafer WF using various measuring methods. Hereinafter, for convenience of description, an example is described in which a 3D structure 3D_STR is generated using the OCD spectrum for the semiconductor wafer WF, but the scope of the present disclosure is not limited thereto, and the OCD spectrum may be changed to various measurement information.

The 3D structure generating device 1300 may receive the OCD spectrum OCD_SPT from the measuring device 1200. The 3D structure generating device 1300 may generate a 3D structure model or 3D structure simulation (hereinafter, for convenience of description, “3D structure 3D_STR”) for a semiconductor pattern (or a semiconductor device or a semiconductor structure) of the semiconductor wafer WF based on the OCD spectrum OCD_SPT.

As an example, a conventional OCD measurement method may generate a plurality of master test specifications MTS corresponding to the semiconductor pattern formed on the semiconductor wafer WF based on the OCD spectrum OCD_SPT. As an example, the master test specifications MTS may be values corresponding to various critical dimensions CD with respect to the semiconductor pattern, and hereinafter, for convenience of description, the MTS is referred to as a “structure value.” For example, a first structure value corresponding to the width of an active region or a channel of a semiconductor pattern may be generated based on the OCD spectrum OCD_SPT. Alternatively, based on the OCD spectrum OCD_SPT, a second structure value corresponding to the length of the active region or the channel of the semiconductor pattern may be generated. However, the structure values generated based on the OCD spectrum OCD_SPT correspond to some of the various structure values for the semiconductor pattern. That is, some structure values for the semiconductor pattern may be obtained based on the OCD spectrum OCD_SPT, but structure values for other parts may not be obtained.

The 3D structure generating device 1300 according to some implementations of the present disclosure may generate the 3D structure 3D_STR for a semiconductor pattern of the semiconductor wafer WF based on the OCD spectrum OCD_SPT. In this case, structure values that are not obtained or not confirmed through the OCD spectrum OCD_SPT may be obtained through the 3D structure 3D_STR. The configuration and operation of the 3D structure generating device 1300 according to some implementations of the present disclosure will be described in more detail with reference to drawings below.

The fault analysis device 1400 may receive the 3D structure 3D_STR for a semiconductor pattern of the semiconductor wafer WF from the 3D structure generating device 1300. The fault analysis device 1400 may perform various fault analyses on the semiconductor pattern of the semiconductor wafer WF based on the 3D structure 3D_STR. For example, the fault analysis device 1400 may extract overall structure values for the semiconductor pattern of the semiconductor wafer WF based on the 3D structure 3D_STR. Alternatively, the fault analysis device 1400 may determine whether the semiconductor pattern of the semiconductor wafer WF is generated normally or as intended based on the 3D structure 3D_STR. Alternatively, the fault analysis device 1400 may detect fault information FT for the semiconductor pattern based on the 3D structure 3D_STR. The fault information FT may be provided to the manufacturing device 1100. The manufacturing device 1100 may adjust process information or process parameters based on the fault information FT such that the semiconductor pattern of the semiconductor wafer WF is optimized (e.g., such that faults are reduced).

In some implementations, the manufacturing device 1100 may form a semiconductor pattern on the semiconductor wafer WF through a plurality of processes. In this case, each time each of the plurality of processes is performed, the measuring device 1200 may measure the OCD spectrum OCD_SPT from the semiconductor wafer WF, and the 3D structure generating device 1300 may generate the 3D structure 3D_STR based on the OCD spectrum OCD_SPT. In this case, a 3D structure 3D_STR_pre of the pre-step generated in a previous process step may be used to generate the 3D structure 3D_STR in the current process step. In this case, since the 3D structures 3D_STR determined or generated at each process step may be accumulated as each process step progresses, the reliability of the final 3D structure 3D_STR may be improved. The above-described configuration will be described in more detail with reference to drawings below.

As an example, a conventional system or method for simulating a 3D structure requires various information such as process information, a critical dimension, etc. required to generate a semiconductor pattern. That is, the conventional system or method for simulating a 3D structure generates a 3D structure of a semiconductor pattern that may be formed depending on predetermined process information and a predetermined critical dimension. On the other hand, according to some implementations of the present disclosure, the 3D structure 3D_STR for a semiconductor pattern may be generated based on the OCD spectrum OCD_SPT acquired from the semiconductor wafer WF in which an actual process is reflected. That is, based on the OCD spectrum OCD_SPT that is actually measured, the 3D structure 3D_STR for a semiconductor pattern that is actually manufactured or generated may be generated. Therefore, in each manufacturing process, the actually manufactured or generated semiconductor pattern is accurately predicted or an identical 3D structure is generated. Accordingly, the reliability of the semiconductor manufacturing process may be improved. In addition, even if a new manufacturing process is added, an accurate evaluation with respect to the new manufacturing process may be made possible based on the 3D structure that is actually identical to the actually formed semiconductor pattern.

In the example of FIG. 1, the manufacturing device 1100, the OCD (Optical Critical Dimension) measuring device 1200, the 3D structure generating device 1300, and the fault analysis device 1400 of the semiconductor manufacturing system 1000 are illustrated as individual components, but the scope of the present disclosure is not limited thereto. For example, some or all of the components of the semiconductor manufacturing system 1000 may be integrated into one device or one machine. Alternatively, the 3D structure generating device 1300 according to some implementations of the present disclosure may be provided in a software form or a hardware form, and when provided in the software form, may be driven by a computer system configured to execute instructions or program codes that perform functions according to the present disclosure.

FIG. 2 is a diagram for describing an operation of a measuring device of FIG. 1. For convenience of description, components which are unnecessary to describe the operation of the measuring device are omitted. Referring to FIGS. 1 and 2, the measuring device 1200 may irradiate light onto the semiconductor wafer WF and may generate the OCD spectrum OCD_SPT based on the light reflected from the semiconductor wafer WF. As illustrated in FIG. 2, the OCD spectrum OCD_SPT indicates the relationship between a wavelength and a spectrum (or intensity).

As an example, the structure values that may be obtained through the OCD spectrum OCD_SPT may be limited. For example, as illustrated in FIG. 2, it is assumed that the measuring device 1200 performs measurement on a semiconductor pattern 10. In this case, the semiconductor pattern 10 may be formed on the semiconductor wafer WF. The semiconductor pattern 10 illustrates a part of the configuration of an MBCFET (Multi Bridge Channel FET). As an example, the semiconductor pattern 10 may be in a state where a shallow trench isolation (STI) process is performed. Based on the OCD spectrum OCD_SPT obtained from the semiconductor pattern 10, first to third structure values MTS1, MTS2, and MTS3 may be obtained. As an example, the first structure value MTS1 may indicate a critical dimension Si_TCD of an upper nanosheet layer, the second structure value MTS2 may indicate a critical dimension Si_BCD of a lower nanosheet layer, and the third structure value MTS3 may indicate a stacking height HT from an element isolation film (i.e., the STI) to the upper nanosheet layer.

As described above, a plurality of structure values may be obtained based on the OCD spectrum OCD_SPT. However, the structure values based on the OCD spectrum OCD_SPT may be limited information. For example, as illustrated in FIG. 2, based on the OCD spectrum OCD_SPT, a depth STI_depth of the element isolation film of the semiconductor pattern 10 may not be obtained. That is, since the MTSs based on the OCD spectrum OCD_SPT have only limited information, the entire structure of the semiconductor pattern 10 may not be accurately measured or confirmed.

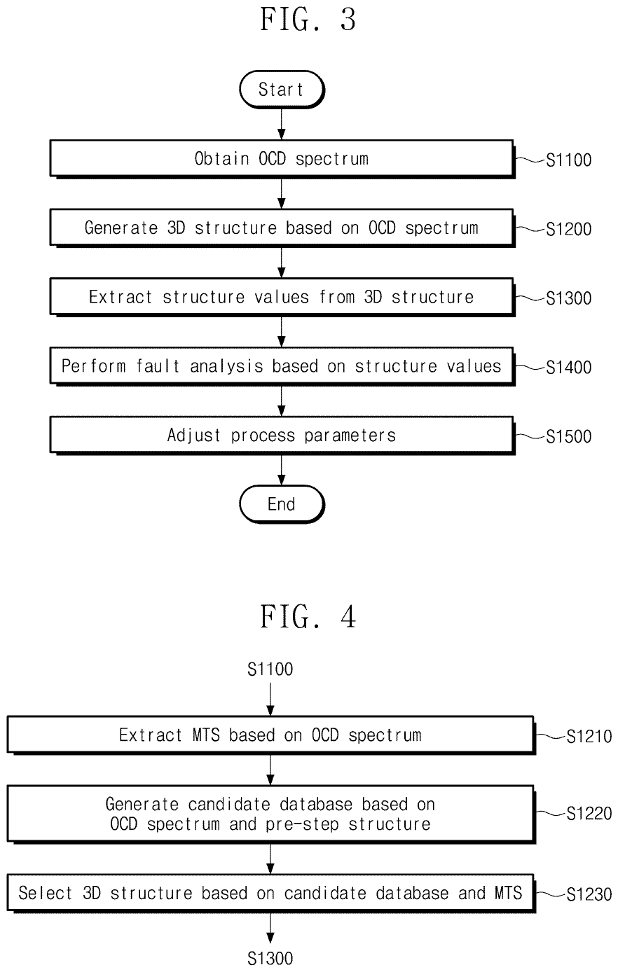

FIG. 3 is a flowchart illustrating an operation of a semiconductor manufacturing system of FIG. 1. Referring to FIGS. 1 and 3, in operation S1100, the semiconductor manufacturing system 1000 may obtain the OCD spectrum OCD_SPT from the semiconductor wafer WF. For example, the measuring device 1200 of the semiconductor manufacturing system 1000 may irradiate light onto the semiconductor wafer WF and may obtain the OCD spectrum OCD_SPT based on the light reflected from the semiconductor wafer WF.

Hereinafter, for convenience of description, the OCD spectrum OCD_SPT obtained by the measuring device 1200 is referred to as an “input OCD spectrum.”

In operation S1200, the semiconductor manufacturing system 1000 may generate the 3D structure 3D_STR based on the input OCD spectrum OCD_SPT. For example, the 3D structure generating device 1300 of the semiconductor manufacturing system 1000 may generate the 3D structure 3D_STR with respect to a semiconductor pattern of the semiconductor wafer WF based on the input OCD spectrum OCD_SPT. The operation of operation S1200 is described in more detail with reference to FIGS. 4 to 11.

In operation S1300, the semiconductor manufacturing system 1000 may extract structure values from the 3D structure 3D_STR. For example, the fault analysis device 1400 of the semiconductor manufacturing system 1000 may extract the structure values with respect to various parts from the 3D structure 3D_STR. In some implementations, the structure values extracted from the 3D structure 3D_STR may include structure values generated based on the OCD spectrum OCD_SPT, and may further include structure values not generated based on the OCD spectrum OCD_SPT. For example, the structure values generated based on the OCD spectrum OCD_SPT may include information corresponding to a first region of the semiconductor wafer WF or the semiconductor pattern. In contrast, the structure values extracted from the 3D structure 3D_STR may include the information corresponding to the first region of the semiconductor wafer WF or the semiconductor pattern, and may further include information corresponding to a second region different from the first region of the semiconductor wafer WF or the semiconductor pattern. That is, through the 3D structure 3D_STR, analysis of regions not identified by the OCD spectrum OCD_SPT with respect to the semiconductor wafer WF or the semiconductor pattern may be possible.

In operation S1400, the semiconductor manufacturing system 1000 may perform a fault analysis based on the structure values. For example, the fault analysis device 1400 of the semiconductor manufacturing system 1000 may perform the fault analysis based on the structure values. As an example, the fault analysis device 1400 may determine whether the structure values have the intended or designed values. Alternatively, the fault analysis device 1400 may perform the fault analysis based on the structure values through various fault analysis algorithms.

In operation S1500, the semiconductor manufacturing system 1000 may adjust process parameters. For example, the manufacturing device 1100 of the semiconductor manufacturing system 1000 may receive the fault information FT from the fault analysis device 1400. The manufacturing device 1100 may adjust the process parameters based on the fault information FT. In some implementations, the manufacturing device 1100 may adjust various process information such that faults in the semiconductor wafer WF or the semiconductor pattern are reduced. In some implementations, the manufacturing device 1100 may perform a subsequent process or proceed with a process for another semiconductor wafer based on the adjusted process information.

FIG. 4 is a flowchart illustrating in detail operation S1200 of FIG. 3. Referring to FIG. 4, a method of generating the 3D structure 3D_STR based on the OCD spectrum OCD_SPT is described. An operation of FIG. 4 is described as being performed by the 3D structure generating device 1300. Referring to FIG. 1, FIG. 3, and FIG. 4, operation S1200 may include operations S1210 to S1230.

In operation S1210, the 3D structure generating device 1300 may extract the plurality of structure values MTS based on the input OCD spectrum OCD_SPT. For example, the 3D structure generating device 1300 may extract a plurality of structure values based on the input OCD spectrum OCD_SPT using a machine learning model. In some implementations, the machine learning model may be trained in advance. In some implementations, the plurality of structure values may include only limited information with respect to a semiconductor pattern of the semiconductor wafer WF.

In operation S1220, the 3D structure generating device 1300 may generate a candidate database based on the extracted structure values MTS. For example, the 3D structure generating device 1300 may generate a plurality of pre-structures by adjusting input parameters (e.g., various critical dimensions, various process information) related to the semiconductor pattern. In some implementations, the plurality of pre-structures may be the results of 3D simulation or 3D modeling in which the input parameters are adjusted with respect to the semiconductor pattern.

The 3D structure generating device 1300 may perform an OCD simulation on each of the plurality of pre-structures to generate a spectrum for each of the plurality of pre-structures. Accordingly, pairs of the plurality of pre-structures and the plurality of spectra associated with the semiconductor pattern are generated. In the detailed description, such information may be referred to as a pre-database. The 3D structure generating device 1300 may generate a function based on input parameters and structure values of pre-structures included in the pre-database. The 3D structure generating device 1300 may select pre-structures that are close to the input OCD spectrum OCD_SPT and the extracted structure values as candidate structures based on the function, and may generate a candidate database based on the selected candidate structures.

In operation S1230, the 3D structure generating device 1300 may select a final 3D structure from the candidate database based on the input OCD spectrum OCD_SPT and the extracted MTS. For example, the 3D structure generating device 1300 may select the final 3D structure 3D_STR that best fits or corresponds to the OCD spectrum OCD_SPT and the extracted structure values MTS from the candidate database. In some implementations, the 3D structure generating device 1300 may select the final 3D structure that corresponds to the input OCD spectrum OCD_SPT and the extracted structure values MTS based on a GOF (Goodness of Fit) model.

In some implementations, the 3D structure generating device 1300 may provide a 3D simulation or a 3D modeling with respect to the final 3D structure, and the fault analysis device 1400 may perform various measurements or fault analyses on the semiconductor wafer WF or the semiconductor pattern based on the 3D simulation or the 3D modeling.

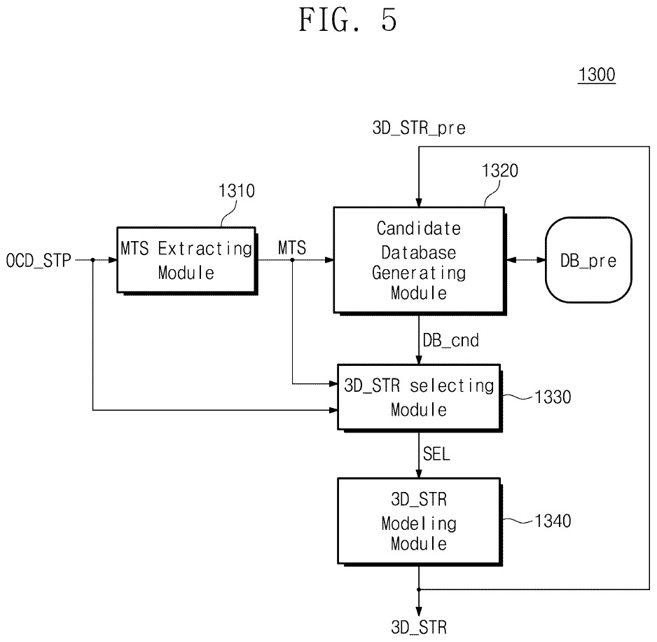

FIG. 5 is a block diagram illustrating a 3D structure generating device of FIG. 1. Referring to FIG. 1 and FIG. 5, the 3D structure generating device 1300 may include a structure value extracting module 1310, a candidate database generating module 1320, a 3D structure selecting module 1330, and a 3D structure modeling module 1340.

The structure value extracting module 1310 may receive the input OCD spectrum OCD_SPT from the measuring device 1200. The structure value extracting module 1310 may extract the plurality of structure values MTS based on the input OCD spectrum OCD_SPT. For example, the structure value extracting module 1310 may extract the plurality of structure values MTS based on the input OCD spectrum OCD_SPT using a machine learning model. In some implementations, the machine learning model may be a trained model in advance. Alternatively, the machine learning model may be trained while the structure value extracting module 1310 performs the extraction operation (i.e., inference). In some implementations, as described above, the plurality of structure values MTS extracted from the input OCD spectrum OCD_SPT may include only limited information with respect to the semiconductor wafer WF or the semiconductor pattern.

The candidate database generating module 1320 may generate a candidate database DB_cnd based on the extracted structure values MTS. For example, the candidate database generating module 1320 may adjust a plurality of input parameters required or used to generate a 3D structure corresponding to the semiconductor pattern of the semiconductor wafer WF. The candidate database generating module 1320 may generate a plurality of pre-structures based on the adjusted input parameters. That is, the plurality of pre-structures may have a shape similar to the semiconductor pattern, but the structure values may be different from each other depending on the adjusted input parameters. The candidate database generating module 1320 may perform OCD simulation on the plurality of pre-structures. Through the OCD simulation, a spectrum for each of the plurality of pre-structures may be generated. The generated plurality of pre-structures and the plurality of spectra may correspond to each other and may be included in a pre-database DB_pre.

The candidate database generating module 1320 may select some of the plurality of pre-structures included in the pre-database DB_pre based on the extracted structure values MTS. For example, the candidate database generating module 1320 may generate a function between input parameters of the plurality of pre-structures included in the pre-database DB_pre and the structure values of the plurality of pre-structures. In some implementations, the function may be generated through various methods such as machine learning or regression analysis. The candidate database generating module 1320 may select pre-structures having similar characteristics to the extracted structure values MTS based on the function as the candidate structures, thereby generating the candidate database DB_cnd. That is, the candidate database DB_cnd may include information on pre-structures having similar characteristics to the extracted structure values MTS and related spectrum information among the plurality of pre-structures of the pre-database DB_pre.

The 3D structure selecting module 1330 may select the final 3D structure from the candidate database DB_cnd based on the plurality of extracted structure values MTS and the input OCD spectrum OCD_SPT. For example, the 3D structure selecting module 1330 may select the final 3D structure corresponding to the input OCD spectrum OCD_SPT and the extracted structure values MTS among the candidate structures included in the candidate database DB_cnd based on the GOF (Goodness of Fit) model. A selection information SEL may be provided to the 3D structure modeling module 1340. In some implementations, the selection information SEL may include information on a plurality of input parameters corresponding to the final 3D structure.

The 3D structure modeling module 1340 may generate the 3D structure 3D_STR based on the selection information SEL with respect to the final 3D structure. In some implementations, the 3D structure modeling module 1340 may generate the 3D structure 3D_STR based on the plurality of input parameters of the selection information SEL.

In some implementations, the final 3D structure 3D_STR may be used as the 3D structure 3D_STR_pre of a pre-step in the generation of a 3D structure after a subsequent process is performed. In this case, the candidate database generating module 1320 may generate a pre-structure by adjusting the remaining input parameters while fixing the input parameters with respect to the 3D structure 3D_STR_pre of the previous step. In this case, the 3D structure 3D_STR selected in the previous process may be reflected in the 3D structure for the current process. Accordingly, the reliability or accuracy of the 3D structure generated as each process is sequentially performed may be improved.

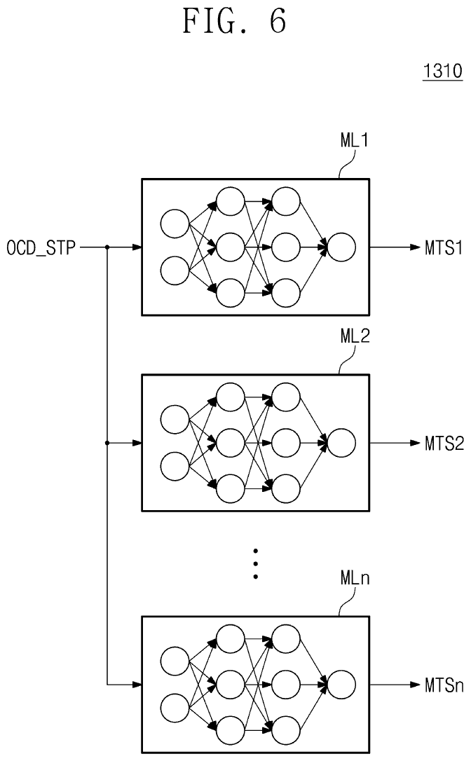

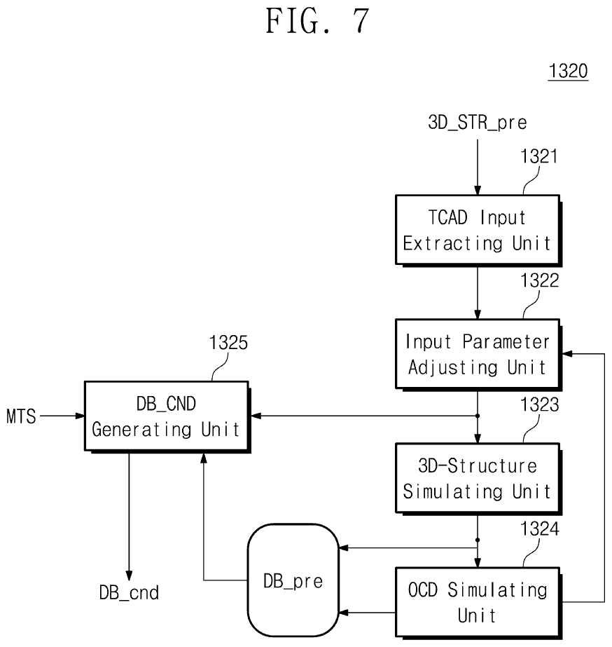

FIG. 6 is a diagram illustrating a structure value extracting module of FIG. 5. Referring to FIGS. 5 and 6, the structure value extracting module 1310 may extract the plurality of structure values MTS1 to MTSn based on the input OCD spectrum OCD_SPT. For example, the structure value extracting module 1310 may include a plurality of models ML1 to MLn. The first model ML1 may be trained to extract the first structure value MTS1 based on the input OCD spectrum OCD_SPT. The second model ML2 may be trained to extract the second structure value MTS2 based on the input OCD spectrum OCD_SPT. The n-th model MLn may be trained to extract the n-th structure value MTSn based on the input OCD spectrum OCD_SPT.

In some implementations, the structure value extracting module 1310 may be implemented using a non-destructive measurement algorithm with respect to the semiconductor wafer WF.

In some implementations, the structure values extracted by the structure value extracting module 1310 may vary depending on the process step of the semiconductor wafer WF. For example, a first input OCD spectrum may be obtained in a state where a deposition process (e.g., CVD (Chemical Vapor Deposition)) for forming a nanosheet for an MBCFET (Multi Bridge Channel FET) is performed on the semiconductor wafer WF. In this case, the structure value extracting module 1310 may extract a plurality of first structure values based on the first input OCD spectrum. Thereafter, a second input OCD spectrum may be obtained in a state where an STI (Shallow trench isolation) process for forming an element isolation film for the MBCFET is performed on the semiconductor wafer WF. In this case, the structure value extracting module 1310 may extract a plurality of second structure values based on the second input OCD spectrum. In this case, the plurality of first structure values may be values for different parts from the plurality of second structure values. Alternatively, some of the plurality of first structure values may be values for the same part as some of the plurality of second structure values. Alternatively, the plurality of first structure values may be different from the plurality of second structure values. The structure value extracting module 1310 may extract some of the plurality of structure values MTS1 to MTSn based on the input OCD spectrum OCD_SPT by using some of the plurality of models ML1 to MLn according to each process step.

FIG. 7 is a block diagram illustrating a candidate database generating module of FIG. 5. Referring to FIGS. 5 and 7, the candidate database generating module 1320 may include a TCAD input extracting unit 1321, an input parameter adjusting unit 1322, a 3D structure simulating unit 1323, an OCD simulating unit 1324, and a candidate database generating unit 1325.

The TCAD (Technology Computer-Aided Design) input extracting unit 1321 may extract input parameters with respect to the 3D structure 3D_STR_pre of the previous step. For example, it is assumed that the 3D structure 3D_STR_pre of the previous step corresponds to the semiconductor pattern 10 of FIG. 2. In this case, the 3D structure 3D_STR_pre of the previous step may be a 3D simulation corresponding to the semiconductor pattern 10 of FIG. 2. Therefore, the TCAD input extracting unit 1321 may extract input parameters (e.g., nano sheet widths (Si_CD1 and Si_CD2), an element isolation film depth (STI_depth), a height (HT) of FIG. 2) for the 3D simulation based on the 3D structure 3D_STR_pre of the previous step. The extracted input parameters may be provided to the input parameter adjusting unit 1322.

The input parameter adjusting unit 1322 may adjust a plurality of input parameters required to generate the 3D structure 3D_STR corresponding to the current process. For example, various input parameters may be required to generate or simulate the 3D structure 3D_STR. The input parameter adjusting unit 1322 may individually adjust each of the input parameters within a specific range. In some implementations, the input parameters may be TCAD input parameters used in 3D modeling or simulation with respect to a corresponding semiconductor pattern.

In some implementations, when input parameters extracted from the TCAD input extracting unit 1321 are received, the input parameter adjusting unit 1322 may fix input parameters corresponding to the extracted input parameters. This may be to extract a 3D structure for a part added in the current process step while the 3D structure 3D_STR_pre of the previous step is fixed. In this case, the 3D structure determined in the previous process may be reflected to the 3D structure of the current process.

The 3D structure simulating unit 1323 may generate a pre-structure based on the adjusted input parameters. For example, the 3D structure simulating unit 1323 may receive adjusted input parameters from the input parameter adjusting unit 1322. The adjusted input parameters may be information necessary for a 3D simulation of a semiconductor pattern corresponding to the current process. The 3D structure simulating unit 1323 may perform a 3D simulation based on the adjusted input parameters to generate a pre-structure. In some implementations, the 3D structure simulating unit 1323 may generate the pre-structure using various software or tools (e.g., TCAD) that provide a 3D simulation with respect to a semiconductor pattern.

The OCD simulating unit 1324 may perform an OCD simulation with respect to the pre-structure generated by the 3D structure simulating unit 1323. The OCD simulating unit 1324 may obtain a pre-spectrum with respect to the pre-structure through the OCD simulation. In some implementations, the pre-spectrum may include some information about the pre-structure.

The pre-structure generated by the 3D structure simulating unit 1323 and the pre-spectrum obtained by the OCD simulating unit 1324 may correspond to each other and may be stored in the pre-database DB_pre.

Thereafter, the input parameter adjusting unit 1322, the 3D structure simulating unit 1323, and the OCD simulating unit 1324 may repeatedly perform the above-described operation to generate the plurality of pre-structures and the plurality of pre-spectra. The generated plurality of pre-structures and the generated plurality of pre-spectra may be stored in the pre-database DB_pre. In some implementations, for convenience of description, the input parameter adjusting unit 1322, the 3D structure simulating unit 1323, and the OCD simulating unit 1324 are described as operating sequentially to generate one pre-structure and one pre-spectrum, but the scope of the present disclosure is not limited thereto. For example, the input parameter adjusting unit 1322, the 3D structure simulating unit 1323, and the OCD simulating unit 1324 may operate in parallel. Alternatively, the input parameter adjusting unit 1322, the 3D structure simulating unit 1323, and the OCD simulating unit 1324 may generate the plurality of pre-structures and the plurality of spectra simultaneously or in parallel.

In some implementations, each of the input parameter adjusting unit 1322, the 3D structure simulating unit 1323, and the OCD simulating unit 1324 may be implemented as software or hardware which are programmed to perform each function in advance. Alternatively, each of the input parameter adjusting unit 1322, the 3D structure simulating unit 1323, and the OCD simulating unit 1324 may be implemented through a dedicated program or dedicated tool configured to perform each function. Alternatively, each of the input parameter adjusting unit 1322, the 3D structure simulating unit 1323, and the OCD simulating unit 1324 may be implemented based on a machine learning model trained in advance to perform each function.

By the operation of the above-described components, the pre-database DB_pre may be generated, and the pre-database DB_pre may include information on the plurality of pre-structures and the plurality of pre-spectra.

The candidate database generating unit 1325 may generate the candidate database DB_cnd from the pre-database DB_pre based on the structure values MTS extracted by the structure value extracting module 1310. For example, the candidate database generating unit 1325 may generate or define a function between input parameters and structure values of each of the plurality of pre-structures included in the pre-database DB_pre. As an example, the function may be generated or defined through various algorithms such as a machine learning model or a regression analysis.

The candidate database generating unit 1325 may select pre-structures satisfying the extracted structure values MTS based on the function. Alternatively, the candidate database generating unit 1325 may select pre-structures having a spectrum similar to the input OCD spectrum OCD_SPT based on the function. The selected pre-structures may be included in the candidate database DB_cnd as the candidate structures.

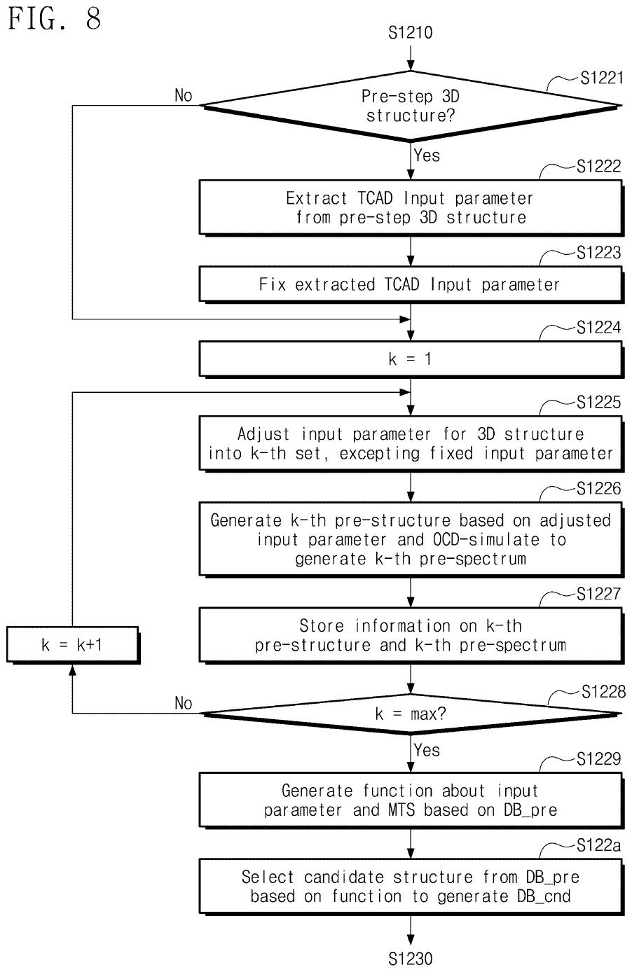

FIG. 8 is a flowchart illustrating operation S1220 of FIG. 4 and an operation of a candidate database generating module of FIG. 7. Referring to FIGS. 4, 7, and 8, operation S1220 may include operation S1221 to operation S122a.

In operation S1221, the candidate database generating module 1320 may determine whether the 3D structure 3D_STR_pre of the previous step exists. For example, as described with reference to FIG. 7, the 3D structure 3D_STR determined in the previous process may be used as the 3D structure 3D_STR_pre of the previous step with respect to the current process. When the first process step for the semiconductor wafer WF is performed, the 3D structure 3D_STR_pre of the previous step may not exist.

When the 3D structure 3D_STR_pre of the previous step exists, in operation S1222, the candidate database generating module 1320 may extract input parameters from the 3D structure 3D_STR_pre of the previous step. For example, the 3D structure 3D_STR_pre of the previous step may be the result of a 3D simulation corresponding to the semiconductor pattern generated by the previous process. Therefore, as described with reference to FIG. 7, the input parameters with respect to the 3D simulation corresponding to the semiconductor pattern generated by the previous process may be extracted through the 3D structure 3D_STR_pre of the previous step.

In operation S1223, the candidate database generating module 1320 may fix the values of the extracted input parameters. For example, for the 3D simulation for the current process, it is assumed that first to tenth input parameters are required, and first to sixth input parameters are extracted through operation S1222. The number of input parameters described above is a simple example, and the scope of the present disclosure is not limited thereto.

In this case, the candidate database generating module 1320 may fix the values for the first to sixth input parameters to the extracted values. In this case, when the input parameters are adjusted in the subsequent operation, the first to sixth input parameters, which are fixed values, will not be adjusted. Accordingly, the 3D structure 3D_STR_pre of the previous step corresponding to the previous process step may be reflected in a fixed form in the 3D structure 3D_STR with respect to the current process.

When the 3D structure 3D_STR_pre of the previous step does not exist, the candidate database generating module 1320 performs operation S1224. That is, when the 3D structure 3D_STR_pre of the previous step does not exist, the input parameters are not fixed.

In operation S1224, a variable “k” is set to “1”. The variable “k” is simply for describing the following iterative operation and should not be understood as having any other technical meaning.

In operation S1225, the candidate database generating module 1320 may adjust the input parameters with respect to the 3D structure to a “k-set”. For example, it is assumed that the variable “k” is “1”. To generate the 3D structure with respect to the current process step, the first to tenth input parameters may be required. In this case, the candidate database generating module 1320 may adjust the first to tenth input parameters to a first set. In some implementations, the first set may include values or information on each of the first to tenth input parameters. That is, the first to tenth input parameters may be adjusted to values defined in the first set.

In some implementations, through operations S1222 and S1223, when some input parameters are fixed, the fixed input parameters will not be adjusted. For example, when the first to sixth input parameters among the first to tenth input parameters are fixed through operations S1222 and S1223, the first to sixth input parameters will have fixed values, and the seventh to tenth input parameters will be adjusted to values corresponding to the first set.

In operation S1226, the candidate database generating module 1320 may generate a k-th pre-structure based on the adjusted input parameters (or may include fixed input parameters), and may perform an OCD simulation on the k-th pre-structure to generate a k-th pre-spectrum. For example, the adjusted input parameters may be information required to generate a 3D structure corresponding to the current process step. Therefore, the candidate database generating module 1320 may perform the 3D simulation based on the adjusted input parameters to generate the k-th pre-structure (i.e., the 3D simulation or modeling corresponding to the current process step). The candidate database generating module 1320 may perform the OCD simulation on the k-th pre-structure to generate the k-th pre-spectrum. In some implementations, the k-th pre-spectrum may be optical information on the k-th pre-structure and may include information on a part of the k-th pre-structure.

In operation S1227, the candidate database generating module 1320 may store information on the k-th pre-structure and the k-th pre-spectrum. For example, the candidate database generating module 1320 may store information on the k-th pre-structure and the k-th pre-spectrum in the pre-database DB_pre.

In operation S1228, whether the variable “k” is a maximum value may be determined. For example, when the variable “k” is not the maximum, it means that there are remaining sets that may be applied to the input parameters. In this case, the variable “k” increases by “1”, and the candidate database generating module 1320 may repeatedly perform operations S1225 to S1228. In some implementations, for convenience of description, an example in which one pre-structure and one pre-spectrum are generated is described, but the scope of the present disclosure is not limited thereto. The candidate database generating module 1320 may perform operations S1225 to S1227 in parallel or simultaneously. Alternatively, the candidate database generating module 1320 may generate the plurality of pre-structures and the plurality of pre-spectra in parallel or simultaneously.

The variable “k” being the maximum means that all sets that may be applied to the input parameters are applied. This means that the pre-database DB_pre is prepared, and the candidate database generating module 1320 performs operations S1229 and S122a.

In operation S1229, the candidate database generating module 1320 may generate a function between input parameters and structure values with respect to the pre-structures based on the pre-database DB_pre. For example, the function may define a relation for what value the structure value for the pre-structure has when the input parameters with respect to the pre-structure are a specific set. In some implementations, the function may be generated through various algorithms such as a machine learning model trained in advance or a regression analysis.

In operation S122a, the candidate database generating module 1320 may select candidate structures based on the function to generate the candidate database DB_cnd. For example, the candidate database generating module 1320 may select pre-structures within an error range with respect to the structure values MTS extracted from the structure value extracting module 1310 among the pre-structures of the pre-database DB_pre based on the function. Alternatively, the candidate database generating module 1320 may select pre-structures corresponding to a pre-spectrum having a similar shape to the input OCD spectrum OCD_SPT among the selected pre-structures. The selected pre-structures may be stored as the candidate structures.

As described above, the candidate database generating module 1320 may generate the candidate database DB_cnd based on the structure values MTS corresponding to the input OCD spectrum OCD_SPT. In this case, each of the candidate structures included in the candidate database DB_cnd may correspond to a spectrum having a shape/pattern similar to that of the input OCD spectrum OCD_SPT, or may have characteristics similar to the structure values MTS extracted from the input OCD spectrum OCD_SPT.

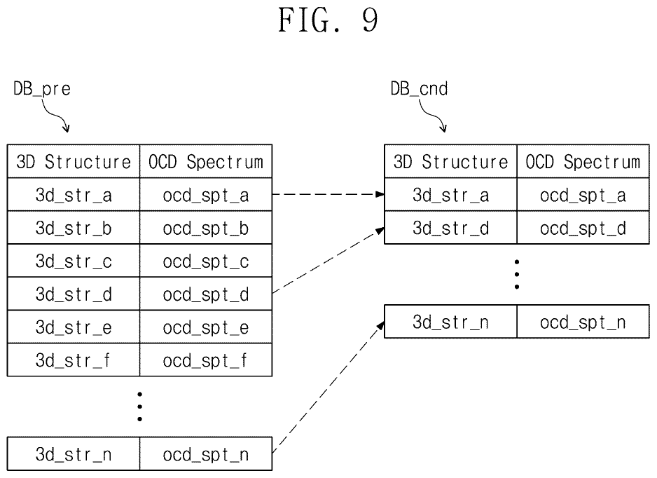

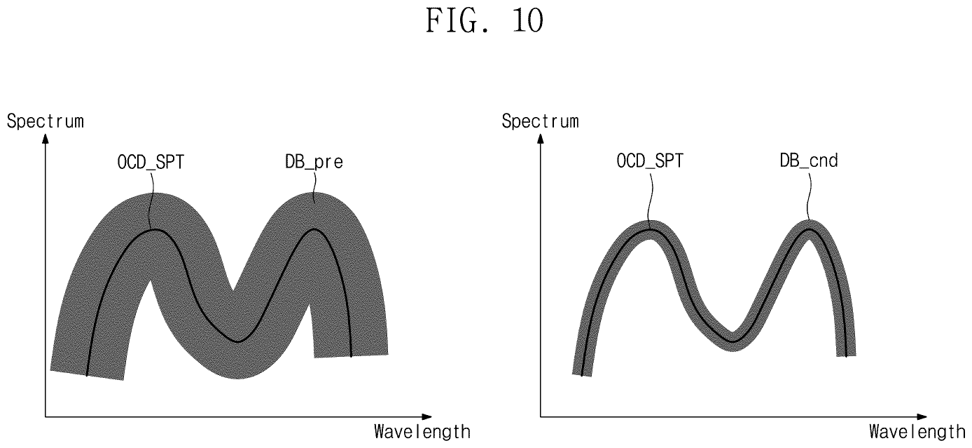

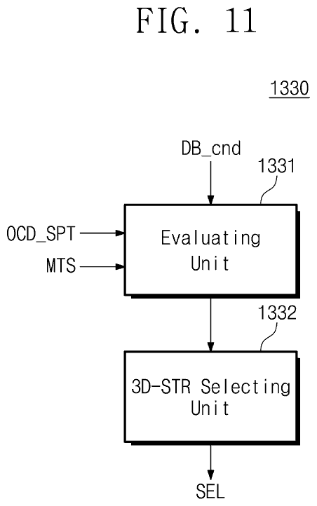

FIG. 9 and FIG. 10 are diagrams for describing a pre-database and a candidate database generated by a candidate database generating module of FIG. 7. Referring to FIGS. 7, 9, and 10, the candidate database generating module 1320 may generate the pre-database DB_pre based on the 3D structure 3D_STR_pre of the previous step. The pre-database DB_pre may include information on a plurality of pre-structures 3d_str_a to 3d_str_n and a plurality of pre-spectra ocd_spt_a to ocd_spt_n. The plurality of pre-structures 3d_str_a to 3d_str_n and the plurality of pre-spectra ocd_spt_a to ocd_spt_n may correspond to each other.

The candidate database DB_cnd may include some information of the pre-database DB_pre. For example, the candidate database DB_cnd may include information on the a-th pre-structure 3d_str_a, the d-th pre-structure 3d_str_d, and the n-th pre-structure 3d_str_n, and information on the pre-spectra ocd_spt_a, ocd_spt_d, and ocd_spt_n corresponding to each of them.

That is, the pre-database DB_pre may indicate a set of structures simulated through a relatively wide range of input parameters with respect to a semiconductor pattern of the current process step, and the candidate database DB_cnd may indicate a set of structures simulated through a relatively narrow range of input parameters with respect to a semiconductor pattern of the current process step. In this case, the range of the input parameters may be determined based on the input OCD spectrum OCD_SPT or the structure values MTS extracted from the input OCD spectrum OCD_SPT.

For example, the input OCD spectrum OCD_SPT may have a form as illustrated in FIG. 10. In this case, the pre-spectra corresponding to the pre-structures included in the pre-database DB_pre may be distributed in a relatively wide range relative to the input OCD spectrum OCD_SPT, as illustrated in FIG. 10. In contrast, the spectra corresponding to the candidate structures included in the candidate database DB_cnd may be distributed in a relatively narrow range relative to the input OCD spectrum OCD_SPT, as illustrated in FIG. 10. Therefore, through the above-described operation, the candidate structures with respect to the current process step may be easily selected based on the input OCD spectrum OCD_SPT.

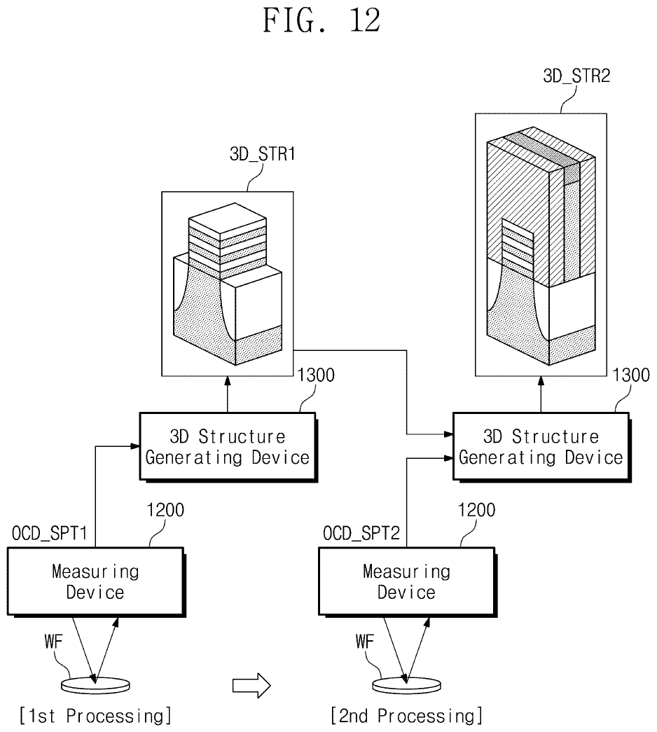

FIG. 11 is a block diagram illustrating a 3D structure selecting module of FIG. 5. Referring to FIG. 5 and FIG. 11, the 3D structure selecting module 1330 may select the final 3D structure 3D_STR from the candidate database DB_cnd based on the input OCD spectrum OCD_SPT and the structure values MTS.

The 3D structure selecting module 1330 may include an evaluating unit 1331 and a 3D structure selecting unit 1332. The evaluating unit 1331 may perform an evaluation on the candidate structures of the candidate database DB_cnd. For example, the evaluating unit 1331 may evaluate whether the spectra and structure values of the candidate structures of the candidate database DB_cnd correspond to the input OCD spectrum OCD_SPT and the structure values MTS extracted from the input OCD spectrum OCD_SPT, respectively. In some implementations, the evaluating unit 1331 may perform the evaluation described above based on the GOF model. The evaluation result may be provided to the 3D structure selecting unit 1332.

The 3D structure selecting unit 1332 may generate the selection information SEL corresponding to the final 3D structure 3D_STR from the candidate database DB_cnd based on the evaluation result of the evaluating unit 1331. In some implementations, the selection information SEL may include information for simulating or modeling the final 3D structure 3D_STR.

In some implementations, the 3D structure 3D_STR selected through the above-described operation may be used as the 3D structure 3D_STR_pre of a previous step for the subsequent process.

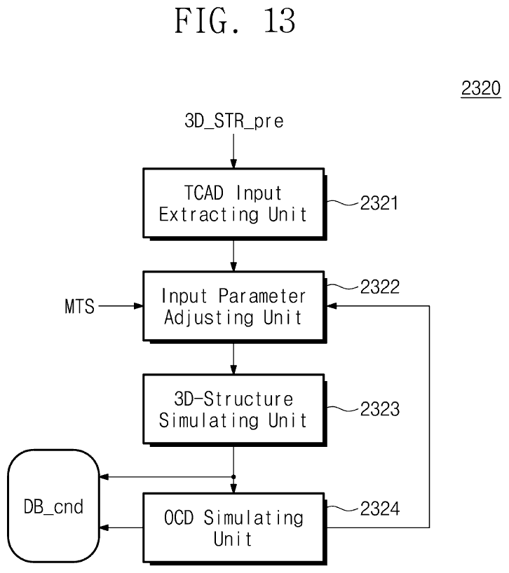

FIG. 12 is a diagram for describing an operation of using a 3D structure of a previous step in a 3D structure generating device of FIG. 5. For convenience of description, an operation of the 3D structure generating device 1300 is described based on some semiconductor patterns formed on the semiconductor wafer WF.

Referring to FIG. 1, FIG. 5, and FIG. 12, a first process for the semiconductor wafer WF may be performed by the manufacturing device 1100. As an example, the first process may refer to a deposition process (e.g., a CVD (Chemical Vapor Deposition) process) for forming a nanosheet with respect to an MBCFET on the semiconductor wafer WF. The measuring device 1200 may perform optical measurement on the semiconductor wafer WF on which the first process is performed to obtain a first OCD spectrum OCD_SPT1. The first OCD spectrum OCD_SPT1 may be transferred to the 3D structure generating device 1300.

The 3D structure generating device 1300 may generate a first 3D structure 3D_STR1 using the first OCD spectrum OCD_SPT1 based on the operation method described with reference to FIGS. 4 to 11. Since the detailed operation method of generating the first 3D structure 3D_STR1 is described above, an additional description thereof is omitted to avoid redundancy.

In some implementations, before the first process with respect to the semiconductor wafer WF is performed, there may be no separate measurement. In this case, the 3D structure generating device 1300 may generate the first 3D structure 3D_STR1 based on the condition that there is no the 3D structure 3D_STR_pre of the previous step (e.g., No of operation S1221 of FIG. 8). In some implementations, the first 3D structure 3D_STR 1 may be a 3D simulation or a 3D modeling having a structure actually identical or similar to a semiconductor pattern on the semiconductor wafer WF on which the first process is performed. The generated first 3D structure 3D_STR1 may be used in a fault analysis by the fault analysis device 1400.

Thereafter, the manufacturing device 1100 may perform a second process on the semiconductor wafer WF. As an example, the second process may be an STI process for forming an element isolation film for an MBCFET on the semiconductor wafer WF. The measuring device 1200 may perform optical measurement on the semiconductor wafer WF on which the second process is performed to obtain a second OCD spectrum OCD_SPT2. The second OCD spectrum OCD_SPT2 may be transferred to the 3D structure generating device 1300.

The 3D structure generating device 1300 may generate a second 3D structure 3D_STR2 using the second OCD spectrum OCD_SPT2 based on the operation method described with reference to FIGS. 4 to 11. Since the operation method of generating the second 3D structure 3D_STR2 is described above, an additional description thereof is omitted to avoid redundancy.

In some implementations, the 3D structure generating device 1300 may generate the candidate database DB_cnd by using the first 3D structure 3D_STR1 corresponding to the first process as the 3D structure 3D_STR_pre of the previous step, and the second 3D structure 3D_STR2 may be generated from the generated candidate database DB_cnd. In this case, a portion of the second 3D structure 3D_STR2 generated by the first process may have the same shape as the first 3D structure 3D_STR1. That is, according to some implementations of the present disclosure, an optimal 3D structure may be determined at each process step, and the optimal 3D structure at each process step may be reflected in determining an optimal 3D structure in a subsequent process. Therefore, as each process step is performed, since the optimal 3D structure at each process step is accumulated, the reliability of the overall 3D structure of the semiconductor wafer WF or the semiconductor pattern may be improved. (That is, the 3D structure is actually identical or similar to an actually manufactured semiconductor pattern.)

FIG. 13 is a block diagram illustrating another example of a candidate database generating module of FIG. 5. A candidate database generating module 2320 of FIG. 13 may correspond to the candidate database generating module 1320 described with reference to FIGS. 1 to 12.

Referring to FIG. 13, the candidate database generating module 2320 may include a TCAD input extracting unit 2321, an input parameter adjusting unit 2322, a 3D structure simulating unit 2323, and an OCD simulating unit 2324. The TCAD input extracting unit 2321, the 3D structure simulating unit 2323, and the OCD simulating unit 2324 are similar to the TCAD input extracting unit 1321, the 3D structure simulating unit 1323, and the OCD simulating unit 1324 of FIG. 7, and therefore, an additional description thereof is omitted to avoid redundancy.

In some implementations, the input parameter adjusting unit 2322 may be configured to adjust input parameters required for modeling a 3D structure. For example, it is assumed that the first to tenth input parameters are required to generate the 3D structure for the current process. In this case, the input parameter adjusting unit 2322 may be configured to adjust each of the first to tenth input parameters.

In some implementations, as described with reference to FIG. 7, the input parameter adjusting unit 2322 may fix the input parameters extracted from the 3D structure 3D_STR_pre of the previous step. For example, it is assumed that the first to tenth input parameters are required to generate a 3D structure for the current process, and the first to sixth input parameters are extracted from the 3D structure 3D_STR_pre of the previous step. In this case, the input parameter adjusting unit 2322 may be configured to fix the first to sixth input parameters to the extracted values, and to adjust each of the seventh to tenth input parameters.

In some implementations, the input parameter adjusting unit 2322 may further fix input parameters corresponding to the extracted structure values MTS (e.g., the structure values extracted from the input OCD spectrum OCD_SPT). For example, it is assumed that the first to tenth input parameters are required to generate a 3D structure for the current process, the first to sixth input parameters are extracted from the 3D structure 3D_STR_pre of the previous step, and the seventh and eighth input parameters correspond to the structure values MTS. In this case, the input parameter adjusting unit 2322 may determine the seventh and eighth input parameters corresponding to the structure values MTS. In some implementations, the values of the seventh and eighth input parameters corresponding to the structure values MTS may be determined through a machine learning model. The input parameter adjusting unit 2322 may be configured to fix the first to sixth input parameters to extracted values (e.g., values extracted by the TCAD input extracting unit 2321), to fix the seventh and eighth input parameters to values corresponding to the structure value MTS, and to adjust the ninth and tenth input parameters.

The 3D structure simulating unit 2323 may simulate the 3D structure based on the adjusted input parameters, and the OCD simulating unit 2324 may perform an OCD simulation on the 3D structure to obtain a spectrum.

The information generated by the 3D structure simulating unit 2323 and the OCD simulating unit 2324 may be stored as the candidate database DB_cnd. In some implementations, since the structure value MTS extracted from the input OCD spectrum OCD_SPT is reflected in advance through the input parameters, the information generated by the 3D structure simulating unit 2323 and the OCD simulating unit 2324 may include information of a relatively narrow range. That is, since the structure value MTS extracted from the input OCD spectrum OCD_SPT is reflected in advance through the input parameters, the candidate database DB_cnd may be generated without generating the pre-database DB_pre.

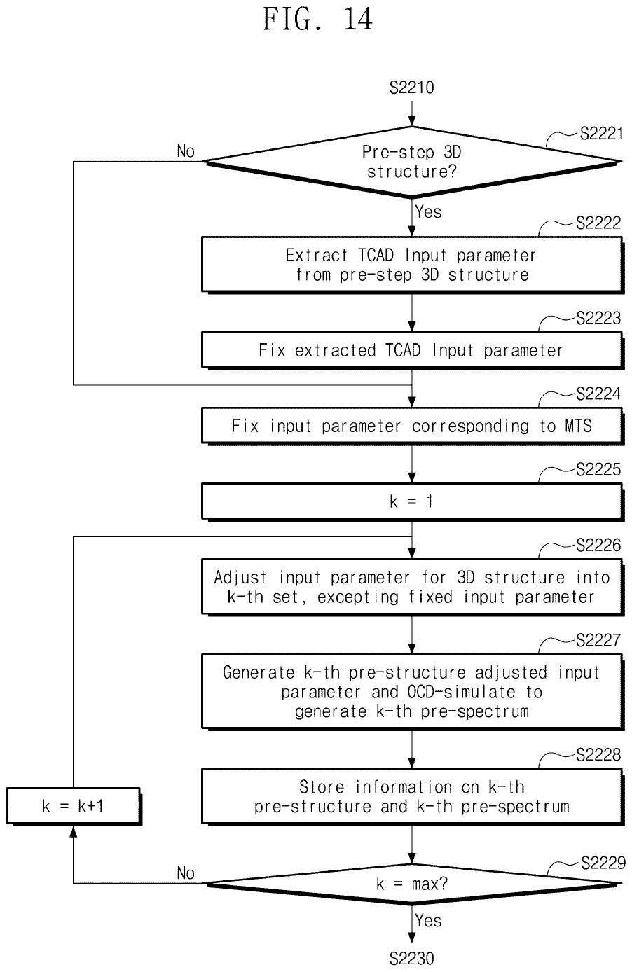

FIG. 14 is a flowchart illustrating an operation of a candidate database generating module of FIG. 13. Referring to FIGS. 13 and 14, the candidate database generating module 2320 may perform operations S2221, S2222, and S2223. Operations S2221, S2222, and S2223 are similar to operations S1221 to S1223 of FIG. 8, so that additional descriptions thereof are omitted to avoid redundancy.

After operation S2223, or when there is no 3D structure in the previous step, in operation S2224, the candidate database generating module 2320 may fix input parameters corresponding to the structure values MTS. For example, the candidate database generating module 2320 may determine input parameters and corresponding values corresponding to the structure values MTS using a machine learning model. The candidate database generating module 2320 may fix input parameters corresponding to the structure values MTS to corresponding values.

Afterwards, the candidate database generating module 2320 may perform operations S2225 to S2229. Except that the input parameters corresponding to the structure values MTS are fixed to corresponding values, operations S2225 to S2229 are similar to operations S1224 to S1228 of FIG. 8, and therefore, additional descriptions thereof are omitted to avoid redundancy.

In some implementations, the pre-structure and pre-spectrum generated through operations S2225 to S2229 may be information reflecting the structure value MTS extracted from the input OCD spectrum OCD_SPT. That is, the pre-structure and pre-spectrum generated through operations S2225 to S2229 may form a relatively narrow-range database, which may be used as the candidate database DB_cnd.

As described above, according to some implementations of the present disclosure, the 3D structure generating device 1300 may generate, simulate, or model the 3D structure 3D_STR for the semiconductor wafer WF or the semiconductor pattern using the OCD spectrum OCD_SPT measured from the semiconductor wafer WF. Accordingly, since the 3D structure 3D_STR for the semiconductor wafer WF or the semiconductor pattern may be generated using the OCD spectrum OCD_SPT that may extract only limited information on the semiconductor wafer WF or the semiconductor pattern, there may be an advantage in a semiconductor process analysis or a fault analysis.

In addition, since the optimal 3D structure generated in the previous process is reflected in the generation of the optimal 3D structure with respect to the current process, the optimal 3D structure in each process may be accumulated as each process is performed. Therefore, the reliability of the overall 3D structure with respect to the semiconductor wafer WF or the semiconductor pattern is improved.

The implementations described above are some implementations of the present disclosure, and the scope of the present disclosure is not limited thereto. For example, in the implementations described above, the configuration and operation of the candidate database generating module 1320 or 2320 are described, but the method of generating the candidate database may be variously modified. For example, instead of generating a separate database, the candidate database generating module may be configured to track the optimal 3D structure 3D_STR corresponding to the input OCD spectrum OCD_SPT and structure value MTS using an algorithm such as a machine learning or a regression analysis. However, the scope of the present disclosure is not limited thereto.

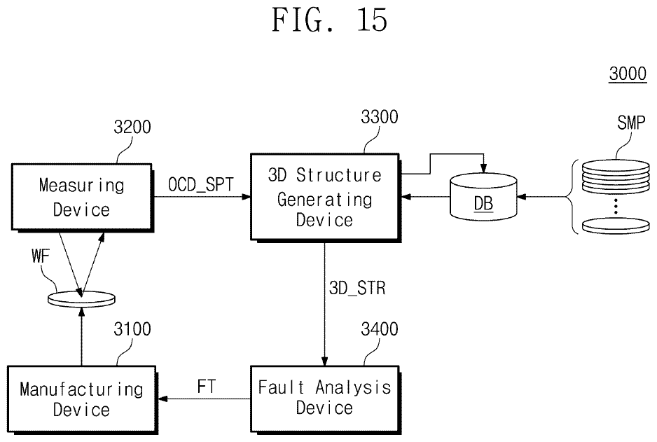

FIG. 15 is a block diagram illustrating a semiconductor manufacturing system, according to some implementations of the present disclosure. Referring to FIG. 15, a semiconductor manufacturing system 3000 may include the semiconductor wafer WF, a manufacturing device 3100, a measuring device 3200, a 3D structure generating device 3300, a fault analysis device 3400, and a database DB. Since the semiconductor wafer WF, the manufacturing device 3100, the measuring device 3200, and the fault analysis device 3400 are similar to those described with reference to FIG. 1, additional descriptions thereof are omitted to avoid redundancy.

In some implementations, in the examples of FIGS. 1 to 14, the 3D structure generating device 1300 may generate a database (e.g., a pre-database, a candidate database, etc.) to generate an optimal 3D structure corresponding to a current process, and may select an optimal 3D structure from the generated database. This may be advantageous in a situation where there are insufficient samples for a semiconductor wafer or a semiconductor pattern (e.g., a situation where a new semiconductor process is applied). However, the scope of the present disclosure is not limited thereto.

For example, there may be a plurality of samples SMP for a specific device (e.g., a transistor). The 3D structure generating device 3300 according to some implementations of the present disclosure may generate the 3D structure 3D_STR based on methods described with reference to FIGS. 1 to 14 during the process of the plurality of samples SMP. Information on the generated 3D structure 3D_STR and information on the corresponding OCD spectrum may be stored in the database DB. That is, the database DB may include information on the 3D structure and the OCD spectrum information with respect to the plurality of samples SMP. The 3D structure generating device 3300 may generate the 3D structure 3D_STR using the database DB with respect to the input OCD spectrum OCD_SPT. In this case, the time for generating an additional database may be shortened.

As described above, according to implementations of the present disclosure, the 3D structure generating device may generate, simulate, or model the 3D structure based on the OCD spectrum with respect to the semiconductor wafer. In this case, various information that may not be obtained through the OCD spectrum may be collected through the 3D structure, and the actual shape of the semiconductor wafer may be confirmed through the 3D structure.

According to some implementations of the present disclosure, a 3D structure for a semiconductor wafer or a semiconductor pattern may be simulated or modeled based on the OCD spectrum used for measurement in a semiconductor manufacturing process. Therefore, various information about a semiconductor pattern that are difficult to obtain through a conventional OCD spectrum may be obtained. In addition, since the 3D structure generated in the current process step is reflected in the next process step, the reliability and accuracy of the overall 3D structure of the semiconductor wafer or the semiconductor pattern may be improved. Accordingly, a semiconductor 3D structure generating device with improved performance and improved reliability and an operation method thereof are provided.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

The above descriptions are detail implementations for carrying out the present disclosure. Implementations in which a design is changed simply or which are easily changed may be included in the present disclosure as well as implementations described above. In addition, technologies that are easily changed and implemented by using the above implementations may be include in the present disclosure. Therefore, the scope of the present disclosure should not be limited to the above-described implementations and should be defined by not only the claims to be described later, but also those equivalent to the claims of the present disclosure.

What is claimed is:

1. A method of generating a semiconductor 3D structure, the method comprising:
receiving, from a measuring device, a first input optical critical dimension (OCD) spectrum with respect to a first semiconductor pattern on a semiconductor wafer;
extracting a plurality of first input structure values based on the first input OCD spectrum;
generating, based on the plurality of first input structure values, a first candidate database including information on a plurality of first candidate structures;
determining, based on the plurality of first input structure values and the first input OCD spectrum, a first candidate structure among the plurality of first candidate structures of the first candidate database; and
generating, based on simulating the first candidate structure, a first 3D structure corresponding to the first semiconductor pattern.

2. The method of claim 1, wherein extracting the plurality of first input structure values based on the first input OCD spectrum is performed using a pre-trained machine learning model.

3. The method of claim 1, wherein generating the first candidate database comprises:
generating, based on adjusting a plurality of first input parameters, a plurality of first pre-structures;
generating, based on performing an OCD simulation on each of the plurality of first pre-structures, a plurality of first pre-spectra; and
generating a first pre-database including (i) the plurality of first pre-structures and (ii) the plurality of first pre-spectra.

4. The method of claim 3, wherein the plurality of first input parameters are inputs of a Technology Computer-Aided Design (TCAD) used in 3D modeling of the first semiconductor pattern.

5. The method of claim 3, wherein generating the first candidate database comprises:
generating a first function between (i) the plurality of first input parameters corresponding to each of the plurality of first pre-structures of the first pre-database and (ii) a plurality of first structure values corresponding to each of the plurality of first pre-structures;
determining, based on the first function, some of the plurality of first pre-structures corresponding to the plurality of first input structure values as the plurality of first candidate structures; and
generating the first candidate database including information on the plurality of first candidate structures.

6. The method of claim 5, wherein the first function is generated based on a machine learning model or a regression analysis algorithm.

7. The method of claim 1, wherein determining the first candidate structure comprises
determining, based on a Goodness of Fit (GOF) model, the first candidate structure corresponding to (i) the plurality of first input structure values and (ii) the first input OCD spectrum, among the plurality of first candidate structures.

8. The method of claim 1, comprising:
receiving, from the measuring device, a second input OCD spectrum with respect to a second semiconductor pattern on the semiconductor wafer;
extracting, based on the second input OCD spectrum, a plurality of second input structure values;
generating, based on (i) the plurality of second input structure values and (ii) the first 3D structure, a second candidate database including information on a plurality of second candidate structures;
determining, based on the plurality of second input structure values and the second input OCD spectrum, a second candidate structure among the plurality of second candidate structures of the second candidate database; and
generating, based on simulating the second candidate structure, a second 3D structure corresponding to the second semiconductor pattern, and
wherein the first semiconductor pattern is formed through a first process with respect to the semiconductor wafer, and
wherein the second semiconductor pattern is formed through a second process performed after the first process with respect to the semiconductor wafer.

9. The method of claim 8, wherein generating the second candidate database comprises:
extracting first input parameters corresponding to the first 3D structure;
generating a plurality of second pre-structures based on (i) setting, among a plurality of second input parameters, second input parameter values corresponding to the first input parameters to extracted first input parameters, and (ii) adjusting remaining parameters among the plurality of second input parameters;
generating a plurality of second pre-spectra based on performing an OCD simulation on each of the plurality of second pre-structures; and
generating a second pre-database including (i) the plurality of second pre-structures and (ii) the plurality of second pre-spectra.

10. The method of claim 9, wherein the plurality of second input parameters are inputs of a TCAD used in 3D modeling of the second semiconductor pattern.

11. The method of claim 9, wherein generating the second candidate database including information on the plurality of second candidate structures comprises:
generating a second function between (i) the plurality of second input parameters corresponding to each of the plurality of second pre-structures of the second pre-database and (ii) a plurality of second structure values corresponding to each of the plurality of second pre-structures;
determining, based on the second function, some of the plurality of second pre-structures corresponding to the plurality of second input structure values as the plurality of second candidate structures; and
generating the second candidate database including information on the plurality of second candidate structures.

12. The method of claim 1, comprising:
determining, based on the first 3D structure, first additional structure values with respect to the first semiconductor pattern,
wherein the first additional structure values include information about (i) a first region of the first semiconductor pattern, and (ii) a second region different from the first region of the first semiconductor pattern.

13. The method of claim 1, wherein the first 3D structure corresponding to the first semiconductor pattern is used for fault analysis by an external fault analysis device.

14. The method of claim 13, comprising:
adjusting, based on a result of the fault analysis, process parameters with respect to the semiconductor wafer.

15. A method of generating a semiconductor 3D structure, the method comprising:
receiving, from an external measuring device, a first input optical critical dimension (OCD) spectrum with respect to a first semiconductor pattern on a semiconductor wafer;
generating, based on the first input OCD spectrum, a first 3D structure corresponding to the first semiconductor pattern;
receiving, from the external measuring device, a second input OCD spectrum with respect to a second semiconductor pattern on the semiconductor wafer; and
generating, based on the second input OCD spectrum and the first 3D structure, a second 3D structure corresponding to the second semiconductor pattern, and
wherein the first semiconductor pattern is formed through a first process with respect to the semiconductor wafer, and
wherein the second semiconductor pattern is formed through a second process performed after the first process with respect to the semiconductor wafer.

16. The method of claim 15, wherein the generating the first 3D structure corresponding to the first semiconductor pattern comprises:
extracting, based on the first input OCD spectrum, a plurality of first input structure values;
generating, based on the plurality of first input structure values, a first candidate database including information on a plurality of first candidate structures;
determining, based on the plurality of first input structure values and the first input OCD spectrum, a first candidate structure among the plurality of first candidate structures of the first candidate database; and
generating, based on simulating the first candidate structure, the first 3D structure.

17. The method of claim 16, wherein generating the second 3D structure corresponding to the second semiconductor pattern comprises:
extracting, based on the second input OCD spectrum, a plurality of second input structure values;
generating, based on the plurality of second input structure values and the first 3D structure, a second candidate database including information on a plurality of second candidate structures;
determining, based on the plurality of second input structure values and the second input OCD spectrum, a second candidate structure among the plurality of second candidate structures of the second candidate database; and
generating, based on simulating the second candidate structure, the second 3D structure corresponding to the second semiconductor pattern.

18. The method of claim 17, wherein the generating the second candidate database including information on the plurality of second candidate structures comprises:
extracting first input parameters corresponding to the first 3D structure;
generating a plurality of second pre-structures based on (i) setting, among a plurality of second input parameters, second input parameter values corresponding to the first input parameters to the first input parameters, and (ii) adjusting remaining parameters among the plurality of second input parameters;
generating a plurality of second pre-spectra based on performing an OCD simulation on each of the plurality of second pre-structures; and
generating a second pre-database including (i) the plurality of second pre-structures and (ii) the plurality of second pre-spectra.

19. The method of claim 18, wherein the generating the second candidate database including information on the plurality of second candidate structures based on the plurality of second input structure values and the first 3D structure includes:
generating a second function between the plurality of second input parameters corresponding to each of the plurality of second pre-structures of the second pre-database and second structure values corresponding to each of the plurality of second pre-structures;
determining, based on the second function, some of the plurality of second pre-structures corresponding to the plurality of second input structure values as the plurality of second candidate structures; and
generating the second candidate database including information on the plurality of second candidate structures.

20. A semiconductor 3D structure generating device comprising:
a structure value extracting module configured to (i) receive, from an external measuring device, a first input optical critical dimension (OCD) spectrum with respect to a first semiconductor pattern on a semiconductor wafer and (ii) extract a plurality of first input structure values based on the first input OCD spectrum;
a candidate database generating module configured to, based on the plurality of first input structure values, generate a first candidate database including information on a plurality of first candidate structures corresponding to the first semiconductor pattern;
a 3D structure selecting module configured to determine, among the plurality of first candidate structures of the first candidate database, a first candidate structure corresponding to (i) the first input OCD spectrum and (ii) the plurality of first input structure values; and
a 3D structure modeling module configured to generate a first 3D structure corresponding to the first semiconductor pattern by simulating the first candidate structure.
